(19) United States
(12) Patent Application Publication
(10) Pub. No.: US 2009/0150952 A1
(43) Pub. Date: Jun. 11, 2009

(54) Video apparatus with web processing function and method for web display

(76) Inventors: Ming-Jen Hsu, Taipei City (TW); Yu-Cheng Chen, Kaohsiung City (TW); Shih-Chang Chen, Sinfong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/216,089

(22) Filed: Jun. 30, 2008

(30) Foreign Application Priority Data
Dec. 5, 2007 (TW) 96146259

(51) Int. Cl. H04N 7/173

(52) U.S. Cl. 725/110

(57) ABSTRACT

A video apparatus with webpage processing function is provided. The present invention comprises a TV signal receiver module, a network connection module, an video processing module, and a display module. The network connection module is used for connecting to the Internet via a network point to capture a web frame. The video processing module is used for receiving a web frame through the network connection module and for receiving a TV frame through the TV signal receiver module, and then outputs the web frame or TV frame to a display module when the network connection module connects to the Internet.

### BACKGROUND OF THE INVENTION

1. Field of the Invention

This invention relates to a video apparatus and particularly to a video apparatus operating on the Internet and method for web display.

2. Description of Related Art

A television (TV) set is generally used for watching TV programs or for watching videos through an external media player. In comparison computers are more often used to access real-time information provided by internet via available network connections.

TV is a piece of common appliance with frequent usage, so there is a demand for the combination of TV set with network access to get the best of both worlds. In a conventional solution, by using a computer system external to the TV set that has a common video communication interface with the TV set, the TV set then may directly receive related frames of the network connection from the computer system and these frames may be directly displayed on the TV set.

Although the above described method may let the TV set display network-based information, but the TV set merely passively receives the network-based information sent from the computer system. If other different network-based information is required, the computer system is still a must for control and execution. The manner of operation is very inconvenient to a user and should be improved, and furthermore the space where the TV set is externally connected to the computer system is wasted.

Consequently, because of the technical limitations of the conventional method as described above, the applicant strived to research and develops the present invention, which can effectively improve the limitations described above.

### SUMMARY OF THE INVENTION

In order to solve technical issues mentioned above, this invention provides a video apparatus with web processing function and method for displaying so that the video apparatus displaying a TV frame may directly connect to the network and automatically retrieve and display web frames.

According to an embodiment of this invention, video apparatus with web processing function is provided, comprising a TV signal receiver module for receiving a TV frame; a network connection module for connecting to the Internet through a network point; a network control module coupled to the network connection module to control the network connection module's connection to the Internet, and also to retrieve web frame data from the Internet, then output the web frame; a network setting module for setting up a web connection address; a video processing module coupled to the network control module and the TV signal receiver module, in order to control the web frame data retrieved by the network control module and to receive the TV frame and the web frame, then outputting a video signal; and finally a display module coupled to the video processing module to output and display the video signal.

The video processing module controls the web connection address retrieved by the network control module according to the web setting module's settings; and selectively switches between the TV frame and the web frame to output the video signal according to a connection command. In another embodiment of present invention, a method for web display on a video apparatus comprises: providing the video apparatus with a network connection module that may connect to the Internet through a network point; receiving a TV frame; setting up a web connection address; connecting to the web connection address on the Internet through the network connection module to retrieve a web frame; selectively switching between the TV frame and the web frame according to a connection command in order to output a video signal to a display module.

In the embodiments, a user may directly connect to the network for automatic retrieval and reading of web frame data via the video apparatus. Thus, not only can the video apparatus be used to display the TV frame but can also display web frame information by means of the network connection function. Such video apparatus would increase the convenience of daily lives.

In order to further elaborate the technical means and effects adopted for the object of present invention, refer to the detailed description of present invention accompanied with drawings; it is believed that the object, features, and points of this invention will be apparent from the description; however, the accompanied drawings are provided for reference and illustrative purpose only and are not meant to limit the present invention.

### BRIEF DESCRIPTION OF THE DRAWINGS

FIG. 1 is a functional block diagram of a video apparatus with web processing function in a preferred embodiment of present invention;

FIG. 2A is a schematic view illustrating a web display according to present invention;

FIG. 2B is a schematic view illustrating another web display according to present invention; and

FIG. 3 is a flow chart of web display on the video apparatus in a preferred embodiment of present invention.

### DETAILED DESCRIPTION OF THE PREFERRED EMBODIMENTS

The present invention will be described more specifically with reference to the following embodiments. It is to be noted that the following descriptions of present invention's preferred embodiments are presented for illustrative purpose only; it is not intended to be exhaustive or to be limited to the precise form disclosed.

In present invention, a video apparatus providing TV programs has additional capability of network processing so that the video apparatus may display a TV frame and process network for web frame browse and then retrieve or search for related real-time information.

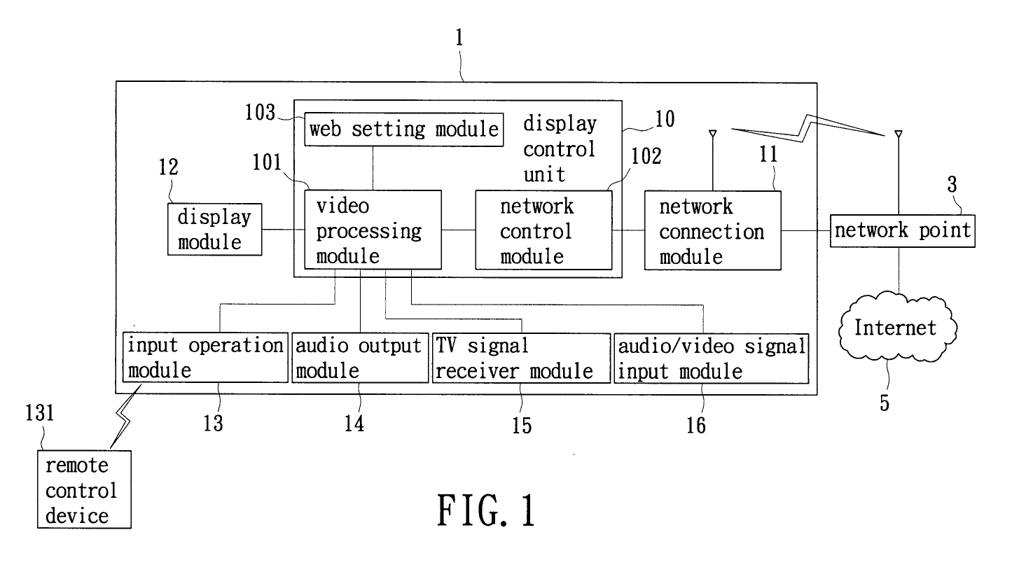

FIG. 1 is a functional block diagram of a video apparatus with web processing function in an embodiment of present invention. In the embodiment, the video apparatus 1 comprises a display control unit 10, a network connection module 11, a display module 12, an input operation module 13, an audio output module 14, a TV signal receiver module 15, and an audio/video input module 16.

In the video apparatus 1, a network connection module 11 is provided to make wireless or wired connection to a network point (NP) 3 connected to Internet 5. The network point can be wireless such as a wireless access point (WAP), or it can be wired such as Ethernet. When being implemented in the embodiment, the network connection module 11 may be wired network connection module or wireless network connection module or both; so that the user may make wired or wireless connection to the network depending on user request. Thus, it is unnecessary that the video apparatus 1 in the embodiment be externally connected to a computer system to connect to Internet 5, as the function is directly implemented by the network connection module 11. The network connection module 11 in the embodiment is designed in standard communication protocols (such as http, UPNP, FTP, or RTSP), in order to directly access AP3 and search on Internet 5 for specific web pages or related network server provided data.

The web in the embodiment is a document assembled with pieces of information of specific scripts, audios, photos, or movies in a standard of html (Hypertext Markup Language), ASP (Microsoft Active Server Page), or PHP (Hypertext Preprocessor).

The display control unit 10 comprises a video processing module 101, a network control module 102, and a web setting module 103. The video processing module 101 is the control core of the complete video apparatus 1 that is used to coordinate each module for tasks and distribute resources. It is also used to output a video signal to a display module 12 for display, and the video signal may be a TV frame or a web frame. The video processing module 101 may command the network control module 102 to connect. In which case the network control module 102 based on the connection command may control the network connection module 11's connection, retrieve specific web frame data from Internet 5, and output the web frame to video processing module 101 according to the retrieved result. The connection command comprises at least a web connection address and the network control module 102 based on the address may retrieve a specific web data.

The web setting module 103 is used to set up the web connection address used by the video processing module 101 for specific web retrieval, and may keep multiple sets of web connection addresses by default, furthermore the content of the web connection address may also be edited and saved.

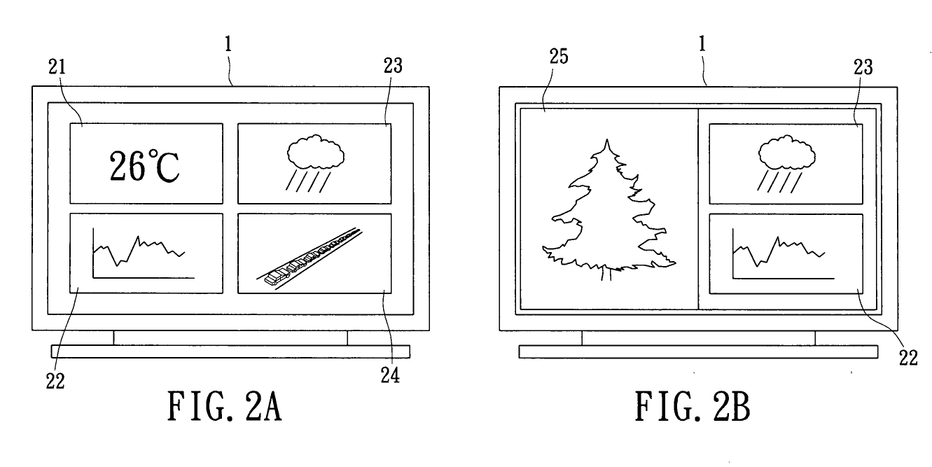

The connection command from the video processing module 101 may be automatically generated when the video apparatus 1 is turned ON or optionally generated when the user makes a request; thus, the network control module 102 based on the connection command may automatically retrieve the web frame for an video processing module 101. Based on the connection command, the video processing module 101 controls the video signal showing the TV frame or the web frame; for example, when the connection command is given, the video signal is switched to the web frame as displayed in FIG. 2A or the display frame of video apparatus 1 may be selectively switched and divided into the web frame and the TV frame that are displayed at the same time, as shown in FIG. 2B. In FIG. 2A, the video apparatus 1 shows a temperature information web 21, a finance information web 22, a weather information web 23, and a road traffic information web 24; in FIG. 2B, the video apparatus 1 shows finance information web 23, weather information web 22, and TV frame 25; the web frames in FIGS. 2A and 2B are taken for example, and the content in web frame and the arrangement of all web frames may be controlled by web setting module 103 and video processing module 101 for diversification of display.

When the connection command indicates no connection to the internet, video processing module 101 would then switches the video signal to output the TV frame to display module 12 to display.

An input operation module 13 is coupled to the video processing module 101 for the user to operate video apparatus 1, and may control video processing module 101 based on user input; such as audio/video playback control and web connection control. Input operation module 13 may serve in the form of a keystroke for the user to operate. The user may also use a remote control device 131 to wirelessly output a remote control signal to input operation module 13 and use input operation module 13 to control video processing module 101. Thus, when connecting the web through video apparatus 1, the user may use input operation module 13 to input the connection command and may modify the web connection address to connect to different webs.

Audio output module 14 coupled to and controlled by video processing module 101 would outputs an audio signal, wherein the audio output module may be a speaker or may be provided with an output terminal to which an external speaker is connected.

TV signal receiver module 15 coupled to video processing module 101 provides video processing module 101 with the TV frame for processing, and the frame is displayed via display module 12. The TV frame provided by TV signal receiver module 15 may be the TV frame broadcast from a cable TV signal or a wireless TV signal. Thus, TV signal receiver module 15 in the embodiment may be one of cable TV signal receiver module, wireless TV signal receiver module, or a single module combined with both modules.

Audio/video signal input module 16 coupled to video processing module 101 may be externally connected to an audio/video playback device and transmit an audio/video playback signal outputted by the audio/video playback device to video processing module 101 for processing.

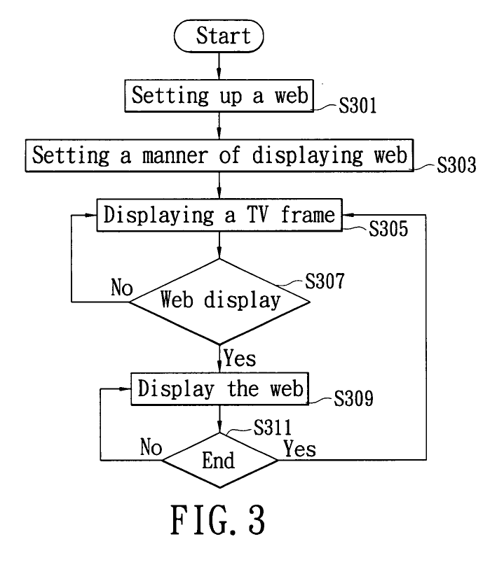

Next, FIG. 3 is a flow chart of web display on the video apparatus in a preferred embodiment of present invention, and make cross-reference with FIG. 1 for related components. First, the web connection address in web setting module 103 may be set through input operation module 13 or remote control device 131, as described at step S301. Further, a manner of web display is set, as described at step S303, and for example display module 12 is set to display only the web frame, as shown in FIG. 2A, or to divide the display frame of video apparatus 1 into the TV frame and the web frame and display them, as shown in FIG. 2B. Next, display module 12 displays the TV frame, as described at step S305, and video apparatus 1 by default display the TV frame at the start.

Then, determine if the web display is required, as described at step S307. Step S307 determines whether the user used input operation module 13 or remote control device 131 to input connection command; if yes at step S307, video processing module 101 outputs the connection command to network control module 102 to automatically connect to the web according to the default web connection address in web setting module 103 or another web connection address directly inputted by the user. Network control module 102 outputs the connected web frame to video processing module 101, and then video processing module 101 based on the setting at step S303 would display the web frame, as described at step S309. Next, determine if the web display should stop, as described at step S311, as for example, the user may use input operation module 13 or remote control device 131 to stop displaying the currently connected web frame, and if the result is yes, step S311 returns to step S305 and video processing module 101 is used to make display module 12 display the TV frame. If the result is no, then the web frame would continue to be displayed.

In addition to the method for web display on video apparatus 1 as shown in FIG. 3 as a flow chart, video apparatus 1, when being booted, may be set to execute the connection command, following a default web connection address to retrieve related information on the web frame and display it on display module 12. Alternatively, video apparatus 1 may execute the connection command at a preset time point so that the user may automatically retrieve the latest related information on the web frame at different points of time.

In the embodiments mentioned above, video apparatus 1 according to present invention may operate to connect to the network without connection to any external computer system. Video apparatus 1 may automatically retrieve the specific web frame to display on display module 12 so that when watching the TV frame through the video apparatus, the user may get real-time network-based information. The real-time network-based information may be given through the default web connection address or a specific web address inputted by the user depending on user demand.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A video apparatus with web processing function, comprising:
a TV signal receiver module for receiving a TV frame;
a network connection module for connecting to the Internet through a network point;
a network control module coupled to the network connection module to control the network connection module's connection to the internet, and also to retrieve web frame data from the Internet, and then output the web frame;
a network setting module for setting up a web connection address;
an video processing module coupled to the network control module and the TV signal receiver module, in order to control the web frame data retrieved by the network control module and to receive the TV frame and the web frame, then outputting a video signal;
wherein, the video processing module controlling the web connection address retrieved by the network control module according to the web setting module's settings, and selectively switches between the TV frame and the web frame to output the video signal according to a connection command; and
a display module coupled to the video processing module to output and display the video signal.

2. The video apparatus with web processing function according to claim 1, wherein the TV signal receiver module is a cable TV signal receiver module and/or a wireless TV signal receiver module.

3. The video apparatus with web processing function according to claim 1, wherein the network connection module is a wired network connection module and/or a wireless network connection module.

4. The video apparatus with web processing function according to claim 1, wherein when the connection command being executed, the video processing module selectively switches the web frame to output the video signal.

5. The video apparatus with web processing function according to claim 1, wherein when the connection command being executed, the video processing module selectively switches the display frame of video apparatus into the TV frame and the web frame to output the video signal.

6. The video apparatus with web processing function according to claim 1, further comprising:
an input operation module coupled to the video processing module for control.

7. The video apparatus with web processing function according to claim 1, further comprising:
a remote control device wirelessly outputting a remote control signal to the input operation module to control the video processing module.

8. The video apparatus with web processing function according to claim 1, further comprising:
an audio output module coupled to the video processing module and being controlled by the video processing module to output an audio signal.

9. The video apparatus with web processing function according to claim 1, further comprising:
an audio/video signal input module coupled to the video processing module and receiving an audio/video playback signal outputted by the audio/video playback device to the video processing module for processing.

10. A method for web display on a video apparatus, comprising:
providing the video apparatus with a network connection module that may connect to the Internet through a network point; receiving a TV frame;
setting up a web connection address;
connecting to the web connection address on the Internet through the network connection module to retrieve a web frame; and
selectively switching between the TV frame and the web frame according to a connection command in order to output a video signal to a display module.

11. The method for web display on a video apparatus according to claim 10, wherein the TV signal is a cable TV signal or a wireless TV signal.

12. The method for web display on a video apparatus according to claim 10, wherein the network connection module is a wired network connection module and/or a wireless network connection module.

13. The method for web display on a video apparatus according to claim 10, wherein when the connection command being executed, the connection command selectively switches the web frame to output the video signal.

14. The method for web display on a video apparatus according to claim 10, wherein when the connection command being executed, the connection command switches a frame divided into the web frame and the TV frame to output the video signal.

15. The method for web display on a video apparatus according to claim 10, wherein when the connection command being not executed, the display module displays the video signal from the TV frame.

16. The method for web display on a video apparatus according to claim 10, wherein the connection command is executed when the video apparatus starts.

17. The method for web display on a video apparatus according to claim 10, wherein the connection command is executed through an input operation module receiving the connection control inputted by a user.

18. The method for web display on a video apparatus according to claim 10, wherein the connection command is executed at a preset time.
